(19) United States
(12) Patent Application Publication
(10) Pub. No.: US 2019/0347084 A1
(43) Pub. Date: Nov. 14, 2019

(54) Method to Dynamically Create Plug and Play Identifiers in Firmware to Facilitate Deployment of Windows Services

(71) Applicant: DELL PRODUCTS, LP, Round Rock, TX (US)

(72) Inventors: Aditi R. Satam, Austin, TX (US); Danilo O. Tan, Austin, TX (US); Kearson M. McNulty, Austin, TX (US); Wai-Ming Richard Chan, Austin, TX (US); Srikanth Kondapi, Austin, TX (US); Steven A. Downum, Pflugerville, TX (US)

(21) Appl. No.: 15/976,454

(22) Filed: May 10, 2018

(51) Int. Cl. G06F 8/65; G06F 8/61; H04L 29/08

(52) U.S. Cl. CPC G06F 8/65; H04L 67/34; G06F 8/61

(57) ABSTRACT

An information handling system includes an application installer, a gateway service, and a driver update service. The application installer retrieves an application from an online application store, and installs the application. The gateway service receives a request to enable a hardware identifier from the application, and enables the hardware identifier and trigger a driver update service. The driver update service checks for an updated driver for the hardware identifier, and downloads and installs the updated driver.

### FIELD OF THE DISCLOSURE

This disclosure generally relates to information handling systems, and more particularly relates to systems and methods to dynamically create plug and play identifiers in firmware to facilitate deployment of windows services.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a block diagram of an information handling system according to one aspect of the disclosure;

FIGS. 2 and 3 are block diagrams of methods for deploying applications and services according to aspects of the disclosure;

FIG. 4 illustrates a flow diagram of a processes for updating a companion service after installing an application according to aspects of the disclosure; and

FIG. 5 illustrates a flow diagram of a process for ensuring dependencies are met before updating firmware according to aspects of the disclosure.

The use of the same reference symbols in different drawings indicates similar or identical items.

### SUMMARY

An information handling system can include an application installer, a gateway service, and a driver update service. The application installer can be configured to retrieve an application from an online application store, and to install the application. The gateway service can be configured to receive a request to enable a hardware identifier from the application, and enable the hardware identifier and trigger a driver update service. The driver update service can be configured to check for an updated driver for the hardware identifier, and download and install the updated driver.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application. The teachings can also be utilized in other applications and with several different types of architectures such as distributed computing architectures, client/server architectures, or middleware server architectures and associated components.

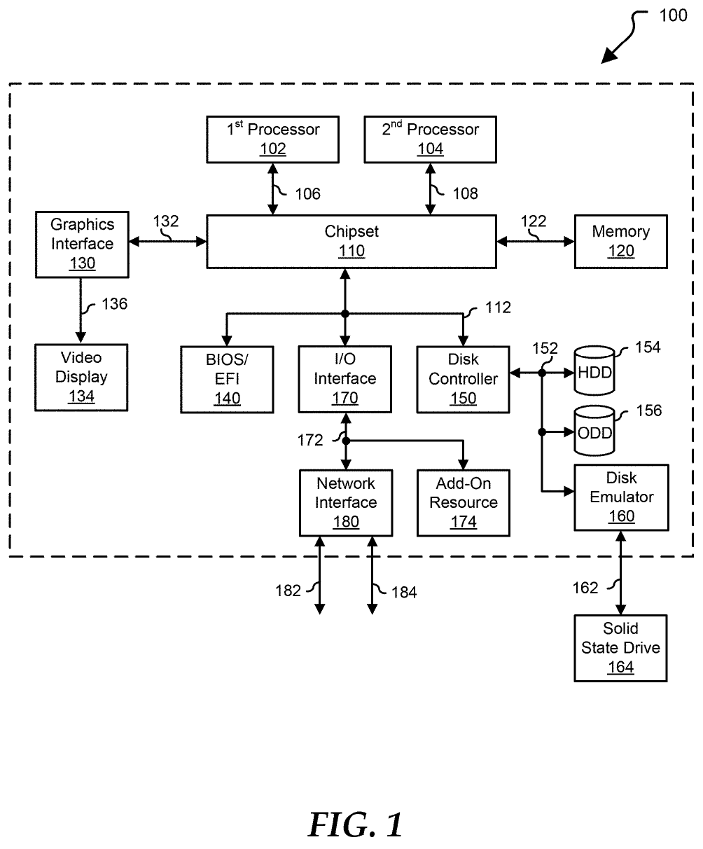

FIG. 1 illustrates a generalized embodiment of information handling system 100. For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 can include devices or modules that embody one or more of the devices or modules described above, and operates to perform one or more of the methods described above. Information handling system 100 includes a processors 102 and 104, a chipset 110, a memory 120, a graphics interface 130, include a basic input and output system/extensible firmware interface (BIOS/EFI) module 140, a disk controller 150, a disk emulator 160, an input/output (I/O) interface 170, and a network interface 180. Processor 102 is connected to chipset 110 via processor interface 106, and processor 104 is connected to chipset 110 via processor interface 108. Memory 120 is connected to chipset 110 via a memory bus 122. Graphics interface 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources. BIOS/EFI module 140 includes code that operates to detect resources within information handling system 100, to provide drivers for the resources, to initialize the resources, and to access the resources.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits a solid-state drive 164 to be connected to information handling system 100 via an external interface 162. An example of external interface 162 includes a USB interface, an IEEE 1134 (Firewire) interface, a proprietary interface, or a combination thereof. Alternatively, solid-state drive 164 can be disposed within information handling system 100.

I/O interface 170 includes a peripheral interface 172 that connects the I/O interface to an add-on resource 174 and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

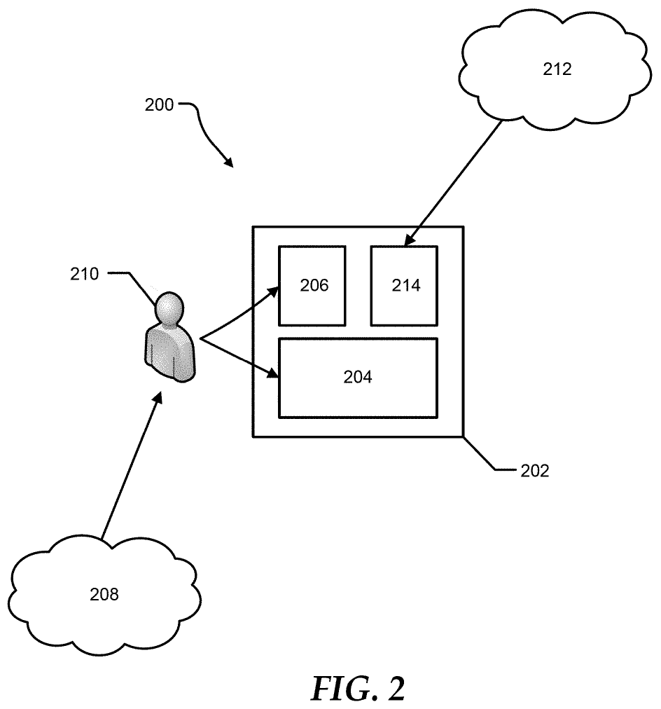

FIG. 2 is a block diagram 200 illustrating mechanisms of software deployment on an client system 202, such as information handling system 100. Traditionally, client system 202 can be shipped with software bundled by the Original Equipment Manufacturer (OEM). The bundled software can include legacy applications 204 and NT Services 206. In various embodiments, the legacy applications 204 and the NT Services 206 can work together to provide a customized experience for client system 202. For example, legacy applications 204 and NT services 206 can support configuration of power management features and other subsystems provided by the OEM. An OEM support site 208 can provide updates to bundled software and/or provide additionally legacy applications 204 and NT Services 206. For example, the OEM support site 208 can provide drivers and related applications for additional hardware that is installed or connected to client system 202 by a user 210. In some embodiments, user 210 may visit the OEM support site and download the latest updates. In some embodiments, an automatic update feature for the OEM software can be enabled, either automatically updating the software or by notifying the user when an update is available.

As another mechanism for software deployment, a curated application store 212 can be provided, such as by the operating system provider. Policies can limit what actions can be performed by applications available through the application store 212, and applications available can go through a screening process to ensure the policies are followed and that malicious code is not made available through the curated application store 212. Additionally, applications available through the application store 212 can be signed by the store provider to certify that the application is “safe”. Store Applications 214 can be downloaded by client system, the signature can be checked, and the software functions made available. Additionally, auto update mechanisms may be enabled so that Store Applications 214 can be periodically updated (with or without user intervention) to ensure the latest software is installed.

In some embodiments, the operating system provider may limit the type of software that can be available in the application store 212. For example, software may be limited to the user level privileges and the applications may be sandboxed or virtualized so that interaction with data from other software and interaction with the system hardware is limited. In other embodiments, the software may be limited to a subset of allowable APIs.

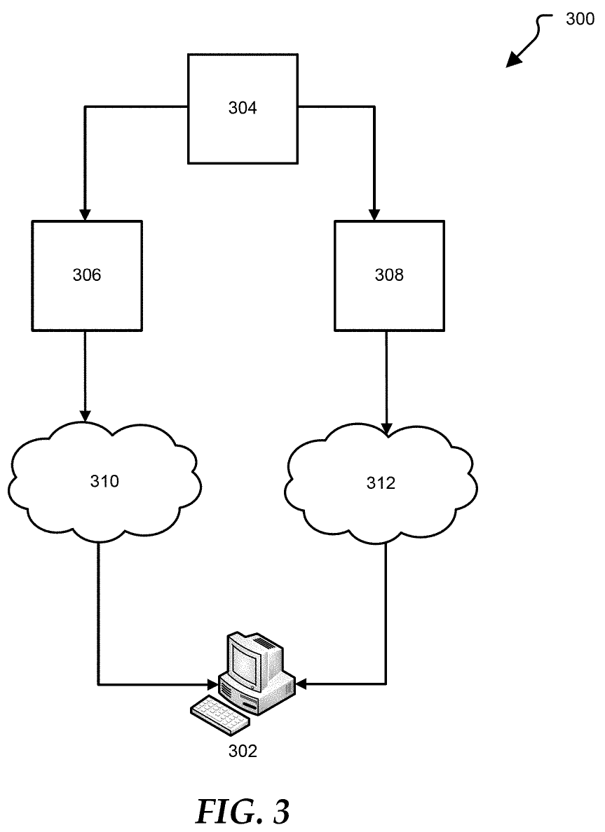

FIG. 3 is a block diagram illustrating a further mechanism 300 for installing software on a client system 302, such as information handling system 100. A hardware provider 304 can split the software into a user interface component 306 and a service component 308. The user interface component 306 can be compatible with the requirements of application store 310, and the service component 308 can be made available through a driver update service 312. Client system 302 can receive updates to the user interface component 306 through the application store 310 and updates to the service component through the driver update service 312.

In various embodiments, an application available through an application store can require a service component to be installed on the system for proper functioning. For example, the application can provide a user interface for configuring subsystems may not have the desired result if the service component is not available to make changes to the operation of the underlying hardware. However, ensuring compatible versions of both the application and the service component are installed can be problematic when splitting the service component and the application providing the user interface. For example, a user may go to the application store and obtain the user interface component and either not follow through or not be aware of the need to install the service component. In another example, the application may receive an update prior to the service component receiving the update. The out of date service component may cause the application to break or may prevent usage of new features of the application until the service component is updated.

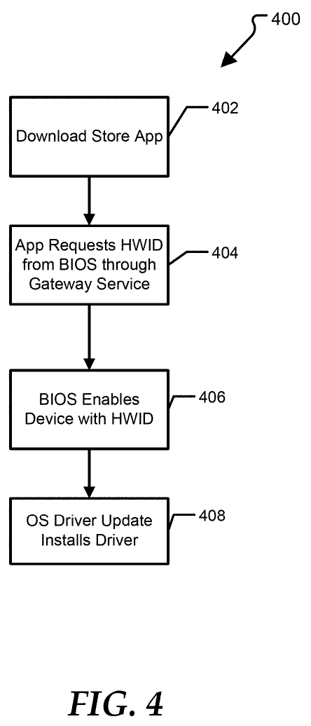

One method to resolve the dependency issues it to invoke a process to install or update the service component when the application is installed. FIG. 4 is a flow diagram illustrating a method 400 of triggering of the service component upon installation of the application. At 402, the application component can be downloaded from the application store. At 404, the application can request a hardware identifier from the BIOS through a gateway service, and at 406, the gateway service can enable the hardware ID. At 408, the driver update service can obtain the latest driver associated with the hardware identifier that happens to be the service component that is necessary for the application.

In various embodiments, the operating system provider can place restrictions on applications available through the application store and drivers available through the driver update service. For example, in Microsoft Windows 10, the driver may be required to be universal. Since a universal driver can be installed on various types of systems, including mobile devices that do not support driver installation during runtime but install drivers on an offline image of the target system, the universal driver may not depend on the runtime behavior of the system and may not utilize any co-installers or other DLLs. Additionally, there may be limitations of the cross-dependencies of applications and drivers installed through the application store and the driver update service. This can be problematic when hardware and firmware components have complex dependencies to avoid system instabilities and to ensure components work as expected. For example, an external hardware component, such as a dock, may need to interact with one or more internal hardware and software components. To ensure integration of the external hardware component and the internal components, upgrades to firmware and software may need coordination. For example, updating the firmware of the external hardware component may require other firmware and software to be updated first. While each firmware or software component provided by the application store and driver update service are required to not have defined cross-dependencies, a mechanism can to be provided to ensure updates are not performed in an uncoordinated manner.

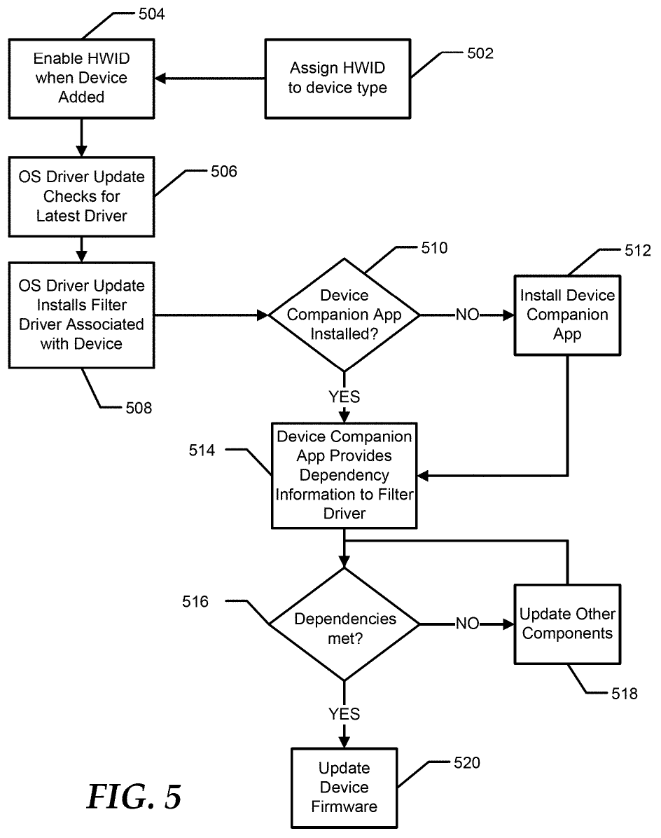

FIG. 5 is a flow diagram illustrating a process for ensuring firmware updates are not applied in a way that would break interoperability. At 502, a unique hardware identifier is assigned for each hardware component or component type. At 504, when the hardware component is added to the system, it becomes visible to the operating system using the pre-defined hardware identifier. At 506, enabling the hardware identifier can cause the operating system to check for a newer version of the device driver through the driver update service.

At 508, when a newer version is available, the driver update service can provide an updated driver to be installed on the system. The updated driver may include a firmware update for the hardware component. However, the firmware update may not be installed on the hardware prior to ensuring dependencies are satisfied. At 510, the driver can check for the presence of a companion application. When the companion application is not present, the driver can cause the companion application to be installed through the application store, as indicated at 512. The companion application can provide dependency information to the driver to ensure all the interoperable components are updated to the required versions, as indicated at 514. At 516, the driver can use the dependency information from the companion application to check if the dependencies are satisfied. At 518, when dependencies are not satisfied, the driver can trigger the driver update service to update other components that do not satisfy the dependency requirement. At 520, once all dependencies are met, the driver can provide the updated firmware to the hardware component.

In various embodiments, a similar mechanism can be used to ensure interoperability of various other software and firmware components by assigning a virtual hardware identifier that can trigger the process.

The systems and methods disclosed improve to computer-related technology. Limiting software available to be installed on and executed on an information handling system can significantly reduce the risk of malicious code execution, improving information security and privacy and reducing maintenance and support requirements. However, such limits can negatively impact the functioning of necessary software. The disclosed systems and methods overcome negative effects of such limits by ensuring components are installed/updated in the proper order and all the necessary components are installed for the proper operation of the application. This reduces the chance of incompatible components crashing the software or otherwise limiting the functionality.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. An information handling system comprising:
a gateway service configured to:
in response to an application being installed, receive a request to enable a hardware identifier from the application, wherein the application is retrieved from an online application store;
receive the hardware identifier from a basic input/output system of the information handling system; and
enable the hardware identifier and trigger a driver update service; and
the driver update service configured to:
check for an updated driver for the hardware identifier; and
download and install the updated driver.

2. The information handling system of claim 1, wherein the driver provides service functions for the application.

3. The information handling system of claim 2, wherein the driver executes service functions at a higher level of access than the application executes instructions.

4. The information handling system of claim 1, wherein the driver is a universal driver and does not utilize co-installers and does not include dependencies.

5. A method for updating firmware of a hardware component, comprising:
installing an updated driver for the hardware component;
obtaining dependency requirements from a companion application, wherein the dependency requirements include information to determine whether interoperable components are updated to required versions;
checking currently installed components against the dependency requirements;
trigger an update for at least one component not satisfying the dependency requirements; and
updating the firmware of the hardware component when the dependency requirements are satisfied.

6. The method of claim 5, further comprising detecting the associated hardware when the hardware component is connected to an information handling system.

7. The method of claim 6, further comprising enabling a hardware identifier corresponding to the hardware component to trigger the update.

8. The method of claim 7, further comprising sending a request to a gateway service to enable the hardware identifier.

9. The method of claim 5, wherein the hardware component is a detachable component.

10. The method of claim 9, wherein the detachable component is a dock.

11. The method of claim 5, wherein the companion application includes updated firmware code.

12. The method of claim 5, further comprising checking for an update to the companion application and installing the update.

13. The method of claim 5, further comprising obtaining dependency requirements from the companion application.

14. The method of claim 5, wherein the driver is a universal driver and does not utilize co-installers and does not include dependencies.

15. A non-transitory computer-readable medium including code that when executed causes a processor to perform a method, the method comprising:
checking a version of a companion application against a minimum version;
triggering installation of an update for the companion application when the version is less than the minimum version;
obtaining a dependency requirement from the companion application, wherein the dependency requirements include information to determine whether interoperable components are updated to required versions;
checking one or more firmware or software versions against the dependency requirement;
triggering installation of updates for the firmware or software components when the dependency requirement is not satisfied; and
updating a firmware of a hardware when the dependency requirement is satisfied.

16. The non-transitory computer-readable medium of claim 15, wherein the hardware is detachable.

17. The non-transitory computer-readable medium of claim 16, wherein the hardware is a dock.

18. The non-transitory computer-readable medium of claim 16, wherein the companion application includes update firmware code.

19. The non-transitory computer-readable medium of claim 15, further comprising detecting the hardware when the hardware is connected to an information handling system.

20. The non-transitory computer-readable medium of claim 19, further comprising enabling a hardware identifier corresponding to the hardware component to trigger the update.
